(19) United States
(12) Patent Application Publication
(10) Pub. No.: US 2020/0307173 A1
(43) Pub. Date: Oct. 1, 2020

(54) METHODS FOR PRODUCING LAMINATE GLASS ARTICLES

(71) Applicant: CORNING INCORPORATED, Corning, NY (US)

(72) Inventors: Paul Bennett Dohn, Corning, NY (US); Vladislav Yuryevich Golyatin, Avon (FR); Butchi Reddy Vaddi, Painted Post, NY (US); Natesan Venkataraman, Painted Post, NY (US)

(21) Appl. No.: 16/307,786

(22) PCT Filed: Jun. 7, 2017
(86) PCT No.: PCT/US2017/036304

§ 371 Date: Dec. 6, 2018

Related U.S. Application Data
(60) Provisional application No. 62/346,819, filed on Jun. 7, 2016.

(51) Int. Cl. B32B 37/18; B32B 17/06; B32B 7/12; C03B 23/203; C03C 27/08; B32B 37/12; B32B 38/00

(52) U.S. Cl. CPC B32B 37/18; B32B 17/06; B32B 7/12; C03B 23/203; C03C 27/08; B32B 37/12; B32B 2315/08; B32B 2038/0016; B32B 2038/002; B32B 2250/40; B32B 2255/24; B32B 2309/02; B32B 2310/0409; B32B 38/0012

(57) ABSTRACT

According to one or more embodiments described herein, a laminate glass article may be produced by a method that includes providing a first glass sheet and a second glass sheet, assembling the first glass sheet and second glass sheet into a glass stack, and bonding the first glass sheet to the second glass sheet to form the laminate glass article. In one or more embodiments, an intermediate layer may be positioned between the first bonding surface and the second bonding surface, the first bonding surface and the second bonding surface may be roughened surfaces, or the first bonding surface and the second bonding surface may be chemically treated by vacuum deposition.

### BACKGROUND

### Field

The present specification generally relates to method for producing glass articles and, more specifically, to methods for producing laminate glass articles comprising at least two glass layers bonded with one another.

### Technical Background

Glass articles, such as cover glasses, glass backplanes, and the like, are employed in both consumer and commercial electronic devices such as LCD and LED displays, computer monitors, automated teller machines (ATMs), and the like. Some of these glass articles may include “touch” functionality, which necessitates that the glass article be contacted by various objects including a user's fingers and/or stylus devices and, as such, the glass must be sufficiently robust to endure regular contact without damage. Moreover, such glass articles may also be incorporated in portable electronic devices, such as mobile telephones, personal media players, and tablet computers. The glass articles incorporated in these devices may be susceptible to damage during transport and/or use of the associated device. Accordingly, glass articles used in electronic devices may require enhanced strength to be able to withstand not only routine “touch” contact from actual use, but also incidental contact and impacts which may occur when the device is being transported.

Various processes may be used to strengthen glass articles, including chemical tempering, thermal tempering, and lamination. A glass article strengthened by lamination is formed from at least two glass compositions which have different coefficients of thermal expansion. These glass compositions may be brought into contact with one another at high temperatures to form the glass article and bond or laminate the glass compositions together. As the glass compositions cool, the difference in the coefficients of thermal expansion cause compressive stresses to develop in at least one of the layers of glass, thereby strengthening the glass article. Lamination processes can also be used to impart or enhance other properties of laminate glass articles, including physical, optical, and chemical properties.

However, laminate glass sheets may have complicated and expensive fabrication processes involving melting the glass compositions to a molten state and down-drawing the compositions to form the laminate. Additionally, glasses which have different viscosities at the forming temperature may not be able to be paired in a laminate by a down-draw process. Accordingly, a need exists for alternative method for producing laminate glass articles.

### BRIEF SUMMARY OF THE INVENTION

According to one embodiment, a laminate glass article may be produced by a method comprising providing a first glass sheet and a second glass sheet, assembling the first glass sheet and second glass sheet into a glass stack, and bonding the first glass sheet to the second glass sheet to form the laminate glass article. The first glass sheet may comprise a first bonding surface and a first sheet thickness in a direction generally orthogonal to the first bonding surface. The second glass sheet may comprise a second bonding surface and a second sheet thickness in a direction generally orthogonal to the second bonding surface. When assembled, the first bonding surface may be aligned with and adjacent to the second bonding surface. In one or more embodiments, an intermediate layer may be positioned between the first bonding surface and the second bonding surface, the first bonding surface and the second bonding surface may be roughened surfaces having an arithmetic average surface roughness (Rₐ) of at least about 3 nm, or the first bonding surface and the second bonding surface may be chemically treated by vacuum deposition. The intermediate layer may comprise glass having a softening point less than the softening point of the first glass sheet and second glass sheet, or the intermediate layer may be sublimed during the bonding. The first glass sheet may be bonded to the second glass sheet at an interface formed by the first bonding surface and the second bonding surface.

According to another embodiment, a laminate glass article may be produced by a method comprising providing a first glass sheet and a second glass sheet, assembling the first glass sheet and second glass sheet into a glass stack, and bonding the first glass sheet to the second glass sheet to form the laminate glass article. The first glass sheet may comprise a first bonding surface and a first sheet thickness in a direction generally orthogonal to the first bonding surface. The second glass sheet may comprise a second bonding surface and a second sheet thickness in a direction generally orthogonal to the second bonding surface. When assembled, the first bonding surface may be aligned with and adjacent to the second bonding surface. In one or more embodiments, an intermediate layer may be positioned between the first bonding surface and the second bonding surface, and the intermediate layer may be sublimed during the bonding. The first glass sheet may be bonded to the second glass sheet at an interface formed by the first bonding surface and the second bonding surface.

Additional features and advantages of the laminate glass articles and method of producing such laminated articles will be set forth in the detailed description which follows, and in part will be readily apparent to those skilled in the art from the description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross-sectional view of a laminate glass article, according to one or more embodiments shown and described herein;

FIG. 2 schematically depicts a process for producing a laminate glass article, according to one or more embodiments shown and described herein;

FIG. 3 schematically depicts a glass stack that includes one or more glass sheets with a roughened bonding surface, according to one or more embodiments shown and described herein;

FIG. 4 schematically depicts a glass stack that includes one or more intermediate layers, according to one or more embodiments shown and described herein;

FIG. 5 schematically depicts a glass stack that includes one or more intermediate layers and one or more spacers, according to one or more embodiments shown and described herein;

FIG. 6 schematically depicts glass stack having one or more glass sheets with a non-planar bonding surface, according to one or more embodiments shown and described herein; and

FIG. 7 schematically depicts a continuous process for producing a laminate glass article, according to one or more embodiments shown and described herein.

### DETAILED DESCRIPTION

Reference will now be made in detail to embodiments of laminate glass articles disclosed herein and methods for producing such laminate glass articles, examples of which are illustrated in the accompanying drawings. Whenever possible, the same reference numerals will be used throughout the drawings to refer to the same or like parts. Generally, laminate glass articles comprise at least two glass layers which are bonded with one another. Laminate glass articles may be produced by heating a glass stack comprising multiple glass sheets to a temperature which bonds the glass sheets with one another, forming the laminate glass article. By bonding the glass sheets together, they become glass layers which may have about the same composition and geometric shape and size as the glass sheets from which they were formed. As described herein, various treatments and modifications can be made to the glass sheets prior to bonding to enhance the bonding and result in a higher quality laminate glass article. For example, the laminate glass articles produced by the methods described herein may have less air pockets, dust particles, and other unwanted materials disposed in the interior region of the laminate glass articles. As described herein, in one embodiment, bonding may be enhanced by utilizing glass sheets which have roughened surfaces where they will be bonded with other sheets. In another embodiment, bonding may be enhanced by utilizing glass sheets which have chemically treated surfaces where they will be bonded with other sheets. In another embodiment, an intermediate layer may be utilized between glass sheets during bonding, where the material of the intermediate layer may decompose and be liberated from the glass stack during bonding, or where, alternatively, the material of the intermediate layer may form an intermediate bonding layer positioned between the glass layers in the bonded laminate glass article.

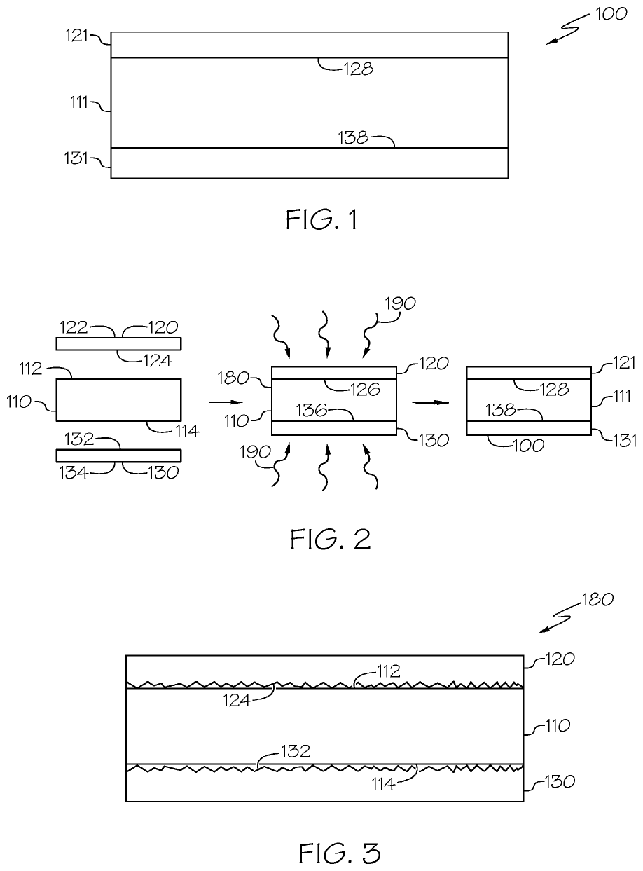

FIG. 1 schematically depicts a cross-sectional view of a laminate glass article 100. The laminate glass article 100 generally includes at least two layers of glass, such three glass layers 111, 121, 131, as depicted in FIG. 1. The glass layers 111, 121, 131 are bonded with one another, either directly or with a relatively thin intermediate bonding layer disposed at the bonded interfaces 128, 138 formed between the glass layers 111, 121, 131. It should be understood that while FIG. 1 depicts three glass layers 111, 121, 131, other embodiments of laminate glass articles 100 may have only two glass layers, or may have more than three glass layers (such as at least 3, at least 4, at least 5, at least 6, at least 7, at least 8, at least 9, or even at least 10 glass layers). The additional glass layers may be positioned adjacent the glass layers 111, 121, 131 depicted and be bonded in a process similar to that described herein.

Still referring to the embodiment of FIG. 1, the laminate glass article 100 includes a first glass layer 111, a second glass layer 121, and a third glass layer 131. The first glass layer 111 is positioned between the second glass layer 121 and the third glass layer 131. The first glass layer 111 is bonded to the second glass layer 121 at a first bonded interface 128, and the first glass layer 111 is bonded to the third glass layer 131 at a second bonded interface 138. As used herein, the term “bonded” refers to a bond between glass layers (such as between first glass layer 111 and second glass layer 121, or between first glass layer 111 and third glass layer 131) formed by raising the material of the glass layers to a temperature sufficient to integrate the two glass layers into a single bonded article.

Now referring to FIG. 2, a method for producing the laminate glass article of FIG. 1 is schematically depicted. FIG. 2 depicts glass sheets 110, 120, 130 being assembled to form a glass stack 180, and the glass stack 180 being heat-treated to bond the glass sheets 110, 120, 130 to form the laminate glass article 100.

According to one or more embodiments, a first glass sheet 110, a second glass sheet 120, and a third glass sheet 130 are provided, as shown in the left-side portion of FIG. 2. The first glass sheet 110 may comprise a first bonding surface 112, and a second bonding surface 114 which is opposed to the first bonding surface 112. The second glass sheet 120 may comprise a bonding surface 124, and an exterior article surface 122 which is opposed to the bonding surface 124. The third glass sheet 130 may comprise an exterior article surface 134, and a bonding surface 132 which is opposed to the exterior article surface 134. Each of the first glass sheet 110, second glass sheet 120, and third glass sheet 130 comprise a thickness in a direction generally orthogonal to the described surfaces of the first glass sheet 110, second glass sheet 120, and third glass sheet 130, respectively. For example, the first glass sheet 110 has a thickness measured between first bonding surface 112 and second bonding surface 114; the second glass sheet 120 has a thickness measured between exterior article surface 122 and bonding surface 124; and the third glass sheet 130 has a thickness measured between bonding surface 132 and exterior article surface 134.

As used herein, a “bonding surface” refers to a surface of any of the first glass sheet 110, the second glass sheet 120, or the third glass sheet 130 to be bonded to another of the first glass sheet 110, the second glass sheet 120, or the third glass sheet 130. For example, with respect to the embodiment of FIG. 2 (showing three glass sheets 110, 120, 130), any of the first bonding surface 112 or second bonding surface 114 of the first glass sheet 110, bonding surface 124 of the second glass sheet 120, or bonding surface 132 of the third glass sheet 130 are considered bonding surfaces.

According to some embodiments, one or more of the first glass sheet 110, the second glass sheet 120, or the third glass sheet 130 may comprise a much greater length and/or width (in directions orthogonal to the direction of measured thickness) than thickness, consistent with the shape of a relatively flat glass sheet which could be utilized as a cover glass on an electronics device. For example, the length and width of the first glass sheet 110, the second glass sheet 120, and the third glass sheet 130 may be at least about 10 times greater, at least about 50 times greater, or even at least about 100 times greater than the thickness of the first glass sheet 110, the second glass sheet 120, or the third glass sheet 130, respectively. According to other embodiments, the glass sheets may be non-planar, such that upon lamination shaped glass sheets are formed.

As depicted in FIG. 2, the first glass sheet 110, the second glass sheet 120, and third glass sheet 130 are assembled into a glass stack 180. According to the embodiment depicted in FIG. 2, bonding surface 124 of the second glass sheet 120 may be aligned with first bonding surface 112 of the first glass sheet 110 to form a portion of the glass stack 180, and bonding surface 132 of the third glass sheet 130 may be aligned with second bonding surface 114 of the first glass sheet to form another portion of the glass stack 180. According to one or more embodiments, the bonding surface 124 and the first bonding surface 112 are adjacent one another, and the first bonding surface 132 and the second bonding surface 114 are adjacent one another. As used herein, two surfaces are adjacent one another when they are in close proximity to, or in direct contact with, one another. For example, two stacked glass sheets may be adjacent to one another by being in direct contact, as shown in FIG. 2. However, it should be understood that surfaces that are adjacent one another need not be in direct contact with one another in all embodiments. For example, according to some embodiments, two glass sheets may be adjacent to one another when they are separated by a relatively thin intermediate layer, such as an intermediate layer having a thickness of about 50 microns or less (such as about 40 microns or less, about 30 microns or less, about 20 microns or less, or even about 10 microns or less. Embodiments comprising intermediate layers are disclosed hereinafter in the present disclosure. Referring still to FIG. 2, the first glass sheet 110 may form an unbonded interface 126 with the second glass sheet 120, and the first glass sheet 110 may form an unbonded interface 136 with the third glass sheet 130.

Prior to the assembly of the glass stack 180, the first glass sheet 110, second glass sheet 120, and/or third glass sheet 130 may be cleaned. According to embodiments, the cleaning may comprise washing with water (such as de-ionized water), or with other cleaning agents or protocols such as H₂O₂, BAKER CLEAN® JTB-100 (commercially available from Avantor Performance Materials), the RCA cleaning process, or the SC-1 portion of the RCA cleaning process. Additionally, in embodiments described herein, the process for fabricating the laminate glass article 100, such as that depicted in FIG. 2, may be performed in a clean room environment which has a low level of dust and/or oxygen. In some embodiments, the assembly of the glass stack 180, the bonding to from the laminate glass article 100, or both, should be performed in an atmosphere of inert gas, such as helium or nitrogen. In some embodiments, the assembly of the glass stack 180 may be performed in the clean room environment under an inert gas and the bonding of the glass stack by heating may be performed outside of such specialized conditions.

According to one or more embodiments, following the assembling of the glass stack 180, the glass stack 180 is bonded to form the laminate glass article 100. During the bonding, the first glass sheet 110 may be bonded to the second glass sheet 120, and the first glass sheet 110 may be bonded to the third glass sheet 130. The resulting laminate glass article 100 comprises a first glass layer 111 positioned between a second glass layer 121 and a third glass layer 131. The second glass layer 121 is bonded to the first glass layer 111 at a first bonded interface 128, and the third glass layer 131 is bonded to the first glass layer 111 at a second bonded interface 138. The bonding of first glass sheet 110 to second glass sheet 120 and third glass sheet 130 may be a result of radiant heating of the glass stack 180. Arrows 190 schematically depict radiant heating of the glass stack 180. While radiant heating may be employed, other heating mechanisms are contemplated herein, such as convective heating and conductive heating. As described herein, the geometry and other physical properties of each of the first glass layer 111, the second glass layer 121, and the third glass layer 131 may be identical to or substantially similar to those of the first glass sheet 110, the second glass sheet 120, and the third glass sheet 130, respectively.

As described herein, the bonding of the glass sheets (e.g., first glass sheet 110 to second glass sheet 120, or first glass sheet 110 to third glass sheet 130) may comprise heating the glass stack 180. The heating may be at a bonding temperature at about the softening point of the materials of the glass sheets 110, 120, 130. In one embodiment, the bonding may be at a bonding temperature range comprising temperatures of greater than or equal to about the softening point of the glass sheet 110, 120, 130 with the lowest softening point. In other embodiments, the bonding temperature range comprises temperatures less than but relatively close to the softening point of the lowest softening point material of the glass sheets 110, 120, 130. According to some embodiments, the bonding may be at a bonding temperature range comprising temperatures of greater than or equal to about 200° C., 100° C., or 50° C. less than the softening point of the glass sheet 110, 120, 130 with the lowest softening point. The term “softening point,” as used herein, refers to the temperature at which a glass composition has a viscosity of about 1×10^{7.6} Poise (P).

According to another embodiment, the bonding may be at a bonding temperature range comprising temperatures of greater than or equal to about 200° C., 100° C., or 50° C. less than the annealing point of the glass sheet 110, 120, 130 with the lowest softening point. The term “annealing point,” as used herein, refers to the temperature at which a glass composition has a viscosity of about 1×10¹³ Poise (P).

According to another embodiment, the bonding may be at a bonding temperature range comprising temperatures of greater than or equal to about 200° C., 100° C., or 50° C. less than the strain point of the glass sheet 110, 120, 130 with the lowest softening point. The term “strain point,” as used herein, refers to the temperature at which a glass composition has a viscosity of about 1×10^{14.5} P.

According another embodiment, the temperature for bonding the glass may depend upon the compositions of the bonded glasses, and suitable bonding temperatures may range from about 625° C. to about 1100° C. (such as from about 625° C. to about 900° C., from about 700° C. to about 1100° C., from about 700° C. to about 1100° C., from about 700° C. to about 1000° C., from about 625° C. to about 850° C., or from about 625° C. to about 950° C.

As described herein, through the bonding of the first glass sheet 110 to the second glass sheet 120 and the third glass sheet 130, the first glass sheet 110, the second glass sheet 120 and the third glass sheet 130 are formed into glass layers (i.e., the first glass layer 111, the second glass layer 121, and the third glass layer 131). Generally, the composition, thickness, coefficient of thermal expansion (CTE), and other properties of the first glass sheet 110, second glass sheet 120, and third glass sheet 130 may be about the same as those of the first glass layer 111, the second glass layer 121, and the third glass layer 131, respectively. For example, the glass composition of each of the first glass layer 111, the second glass layer 121, and the third glass layer 131 may be substantially identical to the glass composition of the first glass sheet 110, the second glass sheet 120, and the third glass sheet 130, respectively. For example, as used herein, “substantially identical” glass compositions refer to two or more glass compositions where each constituent of each glass composition is within about 5 wt. % of the other glass compositions. In one or more embodiments, the thickness of each of the first glass layer 111, the second glass layer 121, and the third glass layer 131 may be about equal to the thickness of the first glass sheet 110, the second glass sheet 120, and the third glass sheet 130, respectively. However, it is contemplated that relatively thin diffusion layers may form between the glass layers which have a composition reflective of a mixture of the bulk glass compositions adjacent the diffusion layers.

Some embodiments of laminate glass articles described herein may be strengthened glass articles, where a core glass layer (the first glass layer 111 of FIG. 1) is sandwiched by two clad glass layers (the second glass layer 121 and third glass layer 131 of FIG. 1). The clad glass layers may have a different coefficient of thermal expansion than the core glass layer, causing compressive stresses to form in the laminate glass article 100 as it is cooled. The term “CTE,” as used herein, refers to the coefficient of linear thermal expansion of the glass composition averaged over a temperature range from about 20° C. to about 300° C. The CTE can be determined, for example, using the procedure described in ASTM E228 “Standard Test Method for Linear Thermal Expansion of Solid Materials With a Push-Rod Dilatometer” or ISO 7991:1987 “Glass—Determination of coefficient of mean linear thermal expansion.” In some embodiments of the laminate glass articles 100 described herein, the first glass layer 111 is formed from a first glass composition having a coefficient of thermal expansion CTE_{core} and the second glass layer 121 and third glass layer 131 formed from a second, different glass composition which has a coefficient of thermal expansion CTE_{clad}. The CTE_{core} may be greater than the CTE_{clad} which results in the second glass layer 121 and third glass layer 131 being compressively stressed and the first glass layer 111 being tensilely stressed without being ion exchanged or thermally tempered. In some embodiments, the thickness of the second glass layer 121, the third glass layer 131, or both, will also be significantly less than the thickness of the first glass layer 111 to achieve higher compressive stress in the second and third glass layers while controlling the tensile stress in the first glass layer to a manageable level. Typically, the thinner cladding layers may be utilized so that the tension in the core layer does not exceed the frangibility limit and cause the laminate to break.

According to some embodiments, one or more of the bonding surfaces 112, 114, 124, 132 may be roughened surfaces. Such an embodiment is depicted in FIG. 3, where bonding surface 124 of the second glass sheet 120 and bonding surface 132 of the third glass sheet 130 are schematically shown as roughened surfaces. While FIG. 3 depicts an embodiment where only the bonding surface 124 of the second glass sheet 120 and the bonding surface 132 of the third glass sheet 130 are roughened surfaces, it should be understood that in other embodiments, two adjacent bonding surfaces, such as the first bonding surface 112 of the first glass sheet 110 and the bonding surface 124 of the second glass sheet 120, or the second bonding surface 114 of the first glass sheet 110 and the bonding surface 132 of the third glass sheet may be roughened surfaces. In some embodiments, substantially the entire surface to be bonded is roughened. According to embodiments, prior to the assembling of the glass sheets 110, 120, 130 and/or the bonding of the glass sheets 110, 120, 130, the bonding surfaces may be roughened by methods such as, but not limited to, acid etching, abrasive blasting, and/or particle deposition. While acid etching, sand blasting, and particle deposition may be suitable methods for forming a roughened surface, it is contemplated that other roughening methods may be utilized.

Without being bound by theory, it is believed that utilizing roughened bonding surfaces may prevent air pocket formation in the laminate glass article 100 by allowing for gasses to exit the system during bonding under heat. Additionally, it is believed that bonding may be enhanced because of the increased surface area of the bonding surfaces available for bonding.

In one or more embodiments, at least one of the bonding surfaces 112, 114, 124, 132 may have an arithmetic average surface roughness (Rₐ) of at least about 3 nm. Unless specified otherwise herein, the surface roughness refers to the arithmetic average surface roughness (Rₐ). As used herein, Rₐ is defined as the arithmetic average of the differences between the local surface heights and the average surface height and can be described by the following equation:

$${R}_{a} = \frac{1}{n} {\sum }_{i = 1}^{n} \vert {y}_{i} \vert ,$$

where yᵢ is the local surface height relative to the average surface height. In one or more embodiments, Rₐ of one or more of the bonding surfaces 112, 114, 124, 132 may be at least about 4 nm, at least about 5 nm, at least about 10 nm, at least about 25 nm, at least about 50 nm, at least about 100 nm, at least about 200 nm, at least about 300 nm, at least about 400 nm, or even at least about 500 nm. For example, Rₐ of one or more of the surfaces that are bonded may be from about 3 nm to about 500, from about 5 nm to about 500, or from about 25 nm to about 500 nm.

According to some embodiments, one or more of the bonding surfaces 112, 114, 124, 132 may be roughened by acid etching. Any suitable acid may be used for the etching process, such as, for example, HCl, HNO₃, or combinations thereof, and the acid may be selected based on the glass compositions of the glass to be etched (i.e., the glass composition of the first glass sheet 110, the second glass sheet 120, and/or the third glass sheet 130). According to another embodiment, one or more of the surfaces that are bonded are roughened by abrasive blasting. As used herein, abrasive blasting refers to the operation of forcibly propelling a stream of abrasive material against a surface under high pressure. A pressurized fluid, typically compressed air, or a centrifugal wheel may be used to propel the blasting media. In one embodiment, the abrasive blasting may be sand blasting (i.e., where the blasting media is sand). In another embodiment, the abrasive blasting may utilize silicon carbide particles as the blasting media.

According to another embodiment, one or more of the bonding surfaces 112, 114, 124, 132 may be roughened by the deposition of particles. According to one or more embodiments, the particles may range in size from about 100 nm to about 10 microns (such as from about 100 nm to about 5 microns, from about 100 nm to about 1 micron, from about 100 nm to about 0.5 microns, from about 100 nm to about 250 nm, from about 250 nm to about 10 microns, from about 0.5 microns to about 10 microns, or from about 1 micron to about 10 microns, or from about 5 microns to about 10 microns, and a dispersion of varying sized particles may be disposed on a single bonding surface 112, 114, 124, 132. According to some embodiments, the particles may be substantially spherical in shape. However, in other embodiments, the particles may have other shapes or form factors, such as irregularly shaped bodies having rounded or substantially flat surfaces, including particles comprising sharp angular features. The particles may have varying sizes. In one embodiment, each particle may have a maximum dimension of from about 100 nm to about 10 microns (such as from about 100 nm to about 1 microns, from about 400 nm to about 900 nm, or from about 400 nm to about 10 microns. As used herein, the “maximum dimension” refers to the greatest distance between surfaces of an individual particle as measured through the volume of the particle. For example, the maximum dimension of a spherical particle is the diameter of the sphere. The “average maximum dimension” refers to the average of the maximum dimensions of all particles deposited onto the bonding surface.

It should be understood that the particles need not be physically attached to the bonding surfaces 112, 114, 124, 132, but in some embodiments, the particles may be attached to the bonding surfaces 112, 114, 124, 132. For example, the particles could be deposited onto the bonding surfaces 112, 114, 124, 132 at an elevated temperature that promotes bonding.

Suitable materials for the particles described herein may include silicon carbide, zirconia, alumina, silica, titania, niobium pentoxide, lanthanum oxide, silicon nitride, or combinations thereof. For example, suitable particles may include glass frit or sand.

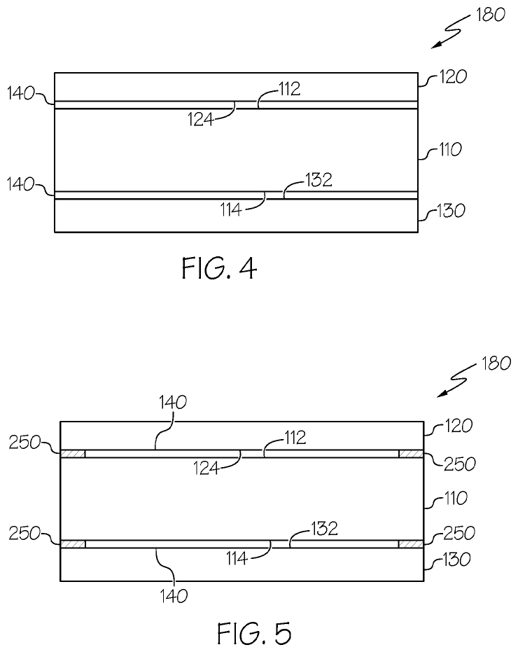

Now referring to FIG. 4, according to one or more embodiments, the glass stack 180 comprises one or more intermediate layers 140 positioned between glass sheets 110, 120, 130 that are bonded to one another. For example, as shown in FIG. 4, an intermediate layer 140 may be positioned between the first glass sheet 110 and the second glass sheet 120, and positioned between the first glass sheet 110 and the third glass sheet 130. According to embodiments, the material of the interlayer 140 in the glass stack 180 may remain in the laminate glass article 100 following the bonding, or may be liberated from the glass stack 180 during the bonding (and not be present in the laminate glass article 100).

The intermediate layer 140 may have a thickness of from about 100 nm to about 50 microns, such as from about 1 micron to about 10 microns, or from about 100 nm to about 1 micron. In embodiments of glass stacks 180 comprising one or more intermediate layers 140, the first glass sheet 110 are not in direct contact with the second glass sheet 120 or the third glass sheet 130. However, the first glass sheet 110 is considered to be adjacent to one or more of the second glass sheet 120 or the third glass sheet 130 when the interlayer 140 has a thickness of less than or equal to about 50 microns (such as about 25 microns or less, about 5 microns or less, or about 1 micron or less).

In one or more embodiments, the intermediate layer 140 may comprise glass, such as a glass with a relatively low softening point relative to the materials of the glass sheets 110, 120, 130. For example, the intermediate layer 140 may be a thin glass sheet. In embodiments, the intermediate layer 140 may comprise or consist of a glass material which has a softening point that is lower than the lowest softening point of the materials of the glass sheets 110, 120, 130. In embodiments, the softening point of the glass material of the intermediate layer 140 may be at least about 50° C. less than the softening point of the first glass sheet 110, the second glass sheet 120, and the third glass sheet 130 (such as at least about 100° C. less, at least about 200° C. less, or even at least bout 300° C. less). The use of a low softening point glass material in the intermediate layer 140 may enable bonding of the glass sheets 110, 120, 130 by the intermediate layer 140 at a relatively low bonding temperature since the glass of the intermediate layer 140 has a lower softening point than that of the first glass sheet 110, the second glass sheet 120, and the third glass sheet 130.

According to other embodiments, the intermediate layer 140 may comprise a porous material or an adhesive. The porous material or the adhesive may sublime under the heat treatment during the bonding process. The porous material or adhesive may comprise or consist of materials that may sublime at elevated temperatures, such as arsenic, antimony, or combinations thereof. According to one or more embodiments, the porous material may comprise a porosity of from about 10% to about 50%, such as from about 10% to about 25% or from about 25% to about 50%.

Referring now to FIG. 5, the glass stack 180 may comprise spacers 250 positioned at or near the perimeter of the glass stack 180 and between one or more of the first glass sheet 110 and the second glass sheet 120, or the first glass sheet 110 and the third glass sheet 130. The spacers may be spaced apart from one another such that gas may be allowed to escape between the spacers during heating. The spacers 250 may operate to prevent the edges of one or more of the first glass sheet 110, the second glass sheet 120, or the third glass sheet 130 from collapsing when the intermediate layer 140 is sublimed. The spacers may comprise or consist of any material that is thermally resistant at sublimation temperatures, for example, glass, silica, metal beads, or other refractory materials. Alternatively or in combination, the spacers be formed as bumps on the glass sheet, which may be made by a laser treatment or other shaping process.

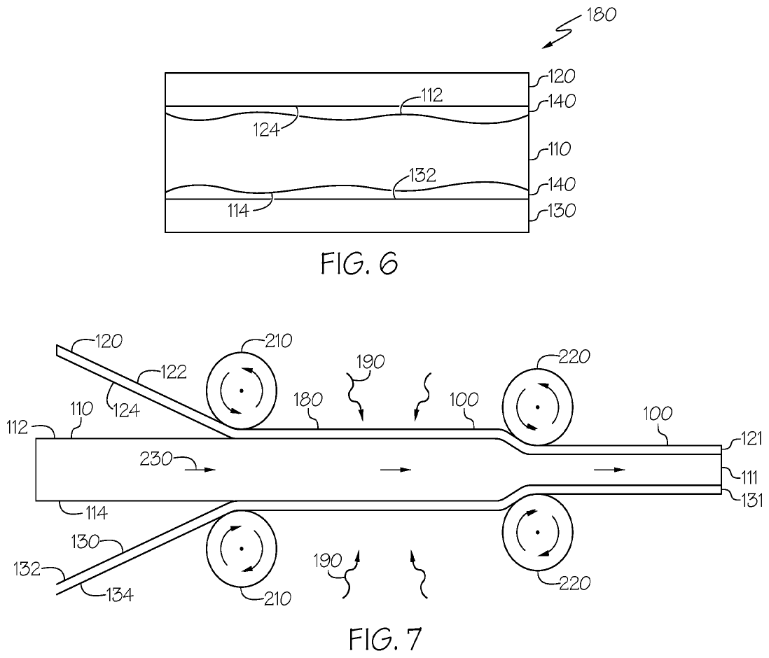

According to another embodiment, one or more of the bonding surfaces 112, 114, 124, 132 may be non-planar, and an intermediate layer 140 may be positioned between the glass sheets 110, 120, 130. For example, FIG. 6 depicts a first glass sheet 110 which is substantially non-planar by having a non-flat first bonding surface 112 and non-flat second bonding surface 114. The intermediate layer 140 may serve to hide the imperfections in the non-planar first glass sheet 110, which may otherwise form air pockets between the first glass sheet 110 and the second glass sheet 120 or the third glass sheet 130 when bonded.

It should be understood that in embodiments of a glass stack 180 which include one or more intermediate layers 140, if a glass material is utilized as the material of the intermediate layer 140, the glass will remain in the laminate glass article 100 as a thin, intermediate bonding layer at the bonded interfaces 128, 138. However, when the intermediate layer 140 is sublimed or otherwise liberated, the material of the intermediate layer 140 is no longer present in the laminate glass article 100, and the first glass sheet 110 may be in direct contact with one or more of the second glass sheet 120 and the third glass sheet 130.

In embodiments in which materials remain in the laminate glass article 100, such as a glass intermediate layer 140 or particles present in a roughened surface, the refractive index of such materials may be about the same as that of one or more of the first glass layer 111, the second glass layer 121, and the third glass layer 131. For example, the refractive index of the particles of a roughened surface or an intermediate layer 140 may be within about 5%, within about 3%, or even within 1% of the refractive index of the first glass layer 111, the second glass layer 121, and/or the third glass layer 131. In such embodiments, the laminate glass article 100 may be perceived as transparent. In another embodiment, the refractive index of the particles of a roughened surface or an intermediate layer 140 may be at least about 1%, at least about 2%, at least about 3%, at least about 4%, at least about 5%, at least about 10%, at least about 20%, at least about 30%, at least about 40%, or even at least about 50% different from (i.e., greater than or less than) the refractive index of the first glass layer 111, the second glass layer 121, and/or the third glass layer 131. In embodiments where a material is inserted into the laminate glass article 100 with a different refractive index from the glass layers 111, 121, and 131, the laminate glass article 100 may have light-scattering properties.

According to another embodiment, prior to assembling of the glass sheets 110, 120, 130 and/or the bonding of the glass sheets 110, 120, 130, one or more of the bonding surfaces 112, 114, 124, 132 may be chemically treated by a vacuum deposition process. In one or more embodiments, the vacuum deposition may be by plasma enhanced chemical vapor deposition (such as by a Applied Precision 5000 deposition apparatus, available from Applied Materials, Inc. of Santa Clara, Calif., USA). The vacuum deposition may deposit a fluorine-containing material, such as materials deposited from CF₄ and CHF₃ vapor deposition. According to one embodiment, the deposition may be at about 50 mTorr at about 200 W for about 1 minute with 30 parts CF₄ and 20 parts CHF₃.

The laminate glass articles 100 described herein may be employed in a variety of consumer electronic devices including, without limitation, mobile telephones, personal music players, tablet computers, LCD and LED displays, automated teller machines and the like.

Now referring to FIG. 7, in one or more embodiments, the process for producing laminate glass article 100 may be performed in a continuous process. It should be understood that the glass sheets 110, 120, 130 may be bonded in a batch process as depicted in FIG. 2. However, as shown in FIG. 7, the glass stack 180 may be formed by merging the first glass sheet 110, the second glass sheet 120 and the third glass sheet 130 under rollers 210. The first glass sheet 110, second glass sheet 120, and third glass sheet 130 move in processing direction 230 to form the glass stack 180. The glass stack 180 is bonded by radiant heating symbolized by arrows 190. Downstream of the bonding by the glass stack 180, rollers 220 may reform the laminate glass article 100, such as by thinning the laminate glass article 100 as depicted in FIG. 7. The formation of the laminate glass article 100 and reforming process may be performed in a continuous process. Following the reforming, the laminate glass article 100 may be partitioned, such as by cutting.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A method for producing a laminate glass article, the method comprising:
assembling a first glass sheet and a second glass sheet into a glass stack, the first glass sheet comprising a first bonding surface and a first sheet thickness in a direction generally orthogonal to the first bonding surface, the second glass sheet comprising a second bonding surface and a second sheet thickness in a direction generally orthogonal to the second bonding surface;
wherein the first bonding surface is aligned with and adjacent to the second bonding surface, and wherein:
at least one of the first bonding surface or the second bonding surface is a roughened surface having an arithmetic average surface roughness (Rₐ) of at least about 3 nm; and
bonding the first glass sheet to the second glass sheet to form the laminate glass article, wherein the first glass sheet is bonded to the second glass sheet at an interface formed by the first bonding surface and the second bonding surface.

2. The method of claim 1, further comprising bonding the first glass sheet to a third glass sheet, wherein the glass stack comprises the third glass sheet, and wherein the first glass sheet is positioned between the second glass sheet and the third glass sheet in the glass stack.

3. The method of claim 1, wherein both of the first bonding surface and the second bonding surface are roughened surfaces having an arithmetic average surface roughness (Rₐ) of at least about 3 nm.

4. The method of claim 1, further comprising roughening the surface of the at least one of the first bonding surface or the second bonding by acid etching.

5. The method of claim 1, further comprising roughening the surface of the at least one of the first bonding surface or the second bonding surface by abrasive blasting.

6. The method of claim 1, further comprising roughening the surface of the at least one of the first bonding surface or the second bonding surface by depositing particles onto the at least one one of the first bonding surface or the second bonding surface.

7. The method of claim 1, wherein one or more of the first bonding surface and the second bonding surface are chemically treated by vacuum deposition.

8. The method of claim 1, wherein the assembling is performed in a clean room environment.

9. The method of claim 1, further comprising cleaning the first glass sheet, the second glass sheet, or both prior to the assembling the glass stack.

10. The method of claim 1, wherein the bonding comprises heating the glass stack to a bonding temperature.

11. The method of claim 10, wherein the bonding temperature is at least about 625° C.

12. The method of claim 10, wherein the bonding temperature is greater than or equal to about 200° C. less than the softening point of the first glass sheet and the second glass sheet.

13. The method of claim 1, further comprising reforming the laminate glass article.

14-15. (canceled)

16. A method for producing a laminate glass article, the method comprising:
assembling a first glass sheet and a second glass sheet into a glass stack, the first glass sheet comprising a first bonding surface and a first sheet thickness in a direction generally orthogonal to the first bonding surface, the second glass sheet comprising a second bonding surface and a second sheet thickness in a direction generally orthogonal to the second bonding surface;
wherein the first bonding surface is aligned with and adjacent to the second bonding surface, and wherein an intermediate layer is positioned between the first bonding surface and the second bonding surface;
bonding the first glass sheet to the second glass sheet to form the laminate glass article, wherein the first glass sheet is bonded to the second glass sheet at an interface formed by the first bonding surface and the second bonding surface, and wherein at least a portion of the intermediate layer is sublimed during the bonding.

17. The method of claim 16, wherein the intermediate layer comprises a porous material having a porosity of from about 10% to about 50%.

18. The method of claim 16, wherein the intermediate layer has a thickness of 50 microns or less.

19. The method of claim 16, wherein the intermediate layer comprises arsenic, antimony, or combinations thereof.

20. The method of claim 1, wherein the at least one of the first bonding surface or the second bonding surface has an arithmetic average surface roughness (Ra) of at most about 500 nm.
